(19) United States
(12) Patent Application Publication
(10) Pub. No.: US 2017/0273015 A1
(43) Pub. Date: Sep. 21, 2017

(54) CELL AND MOBILE TERMINAL DISCOVERY METHOD

(71) Applicant: Electronics & Telecommunications Research Institute, Daejeon (KR)

(72) Inventors: Cheul Soon KIM, Daejeon (KR); Young Jo KO, Daejeon (KR); Jae Young AHN, Daejeon (KR); Sung Hyun MOON, Daejeon (KR); Joon Woo SHIN, Daejeon (KR)

(73) Assignee: Electronics & Telecommunications Research Institute, Daejeon (KR)

(21) Appl. No.: 15/613,685

(22) Filed: Jun. 5, 2017

Related U.S. Application Data
(62) Division of application No. 14/333,165, filed on Jul. 16, 2014.

(30) Foreign Application Priority Data
Jul. 18, 2013 (KR) 10-2013-0085019
May 9, 2014 (KR) 10-2014-0055700
Jul. 16, 2014 (KR) 10-2014-0089542

(51) Int. Cl. H04W 48/16; H04W 56/00

(52) U.S. Cl. CPC H04W 48/16; H04W 56/0015; H04W 56/0045

(57) ABSTRACT

Cell and terminal discovery methods are disclosed. A discovery method performed in a terminal may include transmitting a trigger signal; receiving a discovery signal from at least one cell which receives the trigger signal; measuring the discovery signal; and reporting a measurement result of the discovery signal to a serving cell. Therefore, cell and terminal discoveries may be performed efficiently in cellular mobile communication systems.

### CROSS-REFERENCE TO RELATED APPLICATION

This application is a Divisional of U.S. application Ser. No. 14/333,165 filed on Jul. 16, 2014, which claims the benefit under 35 USC 119(a) of Korean Patent Applications No. 10-2013-0085019 filed on Jul. 18, 2013, No. 10-2014-0055700 filed on May 9, 2014, and No. 10-2014-0089542 filed on Jul. 16, 2014 in the Korean Intellectual Property Office (KIPO), the entire contents of which are hereby incorporated by references.

### BACKGROUND

1. Technical Field

Example embodiments of the present invention relate to mobile communication technology, and more specifically to methods for discovery of cells or mobile terminals which can be applied to a mobile communication system.

2. Related Art

Due to wide distribution of mobile terminals and tablet PCs and rapid advancement of mobile computing based on wireless internet technologies, innovative increase of wireless network capacity is being demanded.

In many studies, it is predicted that traffic amount of mobile users will increase rapidly. An adoption of a new advanced physical layer technology or allocation of additional spectrums is being considered as the representative solutions to satisfy the above rapid explosive increase of traffic amount. However, the physical layer technologies are already approaching their theoretical limits, and allocation of additional frequency spectrum also cannot be a fundamental solution for capacity expansion of cellular networks.

Therefore, demands for technologies, which can increase capacity of a wireless network by hierarchically deploying small cells in sites having much traffic requirements and enabling close cooperation between macro base stations and small cell base stations, are increasing.

In a 3^{rd} Generation Partnership Project (3GPP) standardization organization standardizing Long-Term Evolution (LTE), in order to efficiently accommodate rapidly-increasing data traffic requirements, a standardization on technologies for small cell enhancement (SCE) is going on.

Technologies which are being studied for small cell enhancements may include spectrum efficiency enhancement technologies, small cell activation/deactivation and discovery technologies, interference control technologies, radio-interface based synchronization technologies, physical layer technologies for supporting higher-layer small cell enhancement technologies, etc. Especially, as the cell discovery technologies, discovery types, discovery signals, and discovery procedures are being discussed.

However, only an initial discussion on the cell discovery has been made until now, and specified and efficient methods for the cell discovery have not been proposed yet.

### SUMMARY

Accordingly, example embodiments of the present invention provide efficient cell and terminal discovery methods which can be applied to cellular mobile communication systems.

In some example embodiments, a discovery method performed in a terminal, the method may comprise receiving a discovery signal from at least one cell; measuring the discovery signal; and reporting a measurement result of the discovery signal to a serving cell.

Here, the method may further comprise transmitting a trigger signal, and the terminal may receive the discovery signal from at least one cell which receives the trigger signal.

Here, the transmitting the trigger signal may include receiving configuration information of the trigger signal from the serving cell; and transmitting the trigger signal based on the configuration information of the trigger signal.

Here, the configuration information of the trigger signal may include at least one of information on a signal for the terminal to transmit the trigger signal, information on a time resource and a frequency resource which are used for the terminal to transmit the trigger signal, and information on transmission power of the trigger signal.

Here, the trigger signal may be configured with a Sounding Reference Signal (SRS), and the configuration information of the trigger signal may include at least one of physical layer cell identification information of the serving cell, configuration information on parameters for the at least one cell to receive the SRS, Timing Advance (TA) information for transmitting the SRS, and information on transmission power of the SRS.

Here, the trigger signal may be configured with a Physical Random Access Channel (PRACH), and the configuration information of the trigger signal may include at least one of configuration information of the PRACH and information on transmission power of the PRACH.

Also, the PRACH may be configured with a PRACH sequence reserved for discovery among a set of PRACH sequences.

Here, in the transmitting the trigger signal, the trigger signal may be transmitted periodically according to a preconfigured transmission cycle.

Here, in the transmitting the trigger signal, the terminal may transmit the trigger signal by using a resource used by the serving cell or by using a resource other than resources used by the serving cell.

Here, in the transmitting the trigger signal, the terminal may transmit the trigger signal by using a TA configured by the serving cell.

Here, in the receiving the discovery signal from at least one cell, the terminal may periodically receive the discovery signal from the at least one cell.

Here, the discovery signal may include at least one of a synchronization signal for the terminal to acquire synchronization and a measurement signal for the terminal to perform measurements.

Also, the method may further include receiving, from the serving cell, at least one of configuration information of the synchronization signal and the measurement signal and association information representing a relation between the synchronization signal and the measurement signal.

Also, the configuration information of the synchronization signal may include at least one of information on a transmission cycle and offset of the synchronization signal, a frequency position of the synchronization signal, and sequence generation information of the synchronization signal, and the configuration information of the measurement signal may include at least one identification information of the measurement signal, information on a transmission cycle and offset of the measurement signal, a frequency position of the measurement signal, sequence generation information of the measurement signal, and information on transmission power of the measurement signal.

Also, the association information may be obtained by the terminal through Radio Resource Control (RRC) signaling of the serving cell, and include identification information of a synchronization signal used for acquiring time and/or frequency synchronization for demodulation of the measurement signal when the terminal receives the measurement signal and performs radio resource measurement (RRM) on the measurement signal.

Also, when the synchronization signal is configured with a Primary Synchronization Signal (PSS) and a Secondary Synchronization Signal (SSS) and the measurement signal is configured with a Channel State Information-Reference Signal (CSI-RS) and/or a Cell Specific Reference Signal (CRS), the association information may include identification information of a synchronization signal for each measurement signal transmitted from at least one cell, and the identification information of the synchronization signal includes a physical-layer cell identification information (Physical Cell Identity: PCI).

Here, the method may further include receiving TA information applied to the synchronization signal and the measurement signal from the serving cell.

Here, the measuring the discovery signal may include receiving the discovery signal based on the configuration information of the discovery signal; acquiring time synchronization based on the received discovery signal; and receiving the measurement signal included in the discovery signal based on the association information, and performing measurements on the received measurement signal.

In other example embodiments, a discovery method performed in a cell, the method may comprise performing measurements on a trigger signal transmitted from a terminal; estimating a proximity to the terminal based on the measurement result; and when the estimated proximity meets a preconfigured threshold, transmitting a discovery signal to the terminal.

Here, the method may further comprise receiving configuration information of the trigger signal from a serving cell of the terminal, wherein in the performing measurements on the trigger signal, the trigger signal is received and measured based on the configuration information of the trigger signal.

Here, the performing measurements on the trigger signal may include receiving the trigger signal earlier than a uplink subframe reception timing of the serving cell of the terminal, as early as a propagation delay time between the serving cell and the terminal.

Here, the performing measurements on the trigger signal may include comparing reception strength of a received signal with a preconfigured threshold; and determining whether to receive the trigger signal and/or estimating the proximity to the terminal, based on the comparison result.

Here, in the performing measurement on the trigger signal, when a Physical Random Access Channel (PRACH) is received as the trigger signal, a sequence of the PRACH is checked, and a random access response for the PRACH is not transmitted when the sequence is a sequence reserved for discovery.

Here, the discovery signal may include at least one of a synchronization signal for uplink synchronization acquisition of the terminal and a measurement signal for measurement of the terminal, and, in the transmitting the discovery signal to the terminal, the synchronization signal and/or the measurement signal may be transmitted periodically, and transmission cycles of the synchronization signal and the measurement signal are configured to be identical to or different from each other.

Here, the method may further comprise receiving a Sounding Reference Signal (SRS) from the terminal when the cell is in active state or in discontinuous transmission (DTX) state.

Here, the method may further comprise updating, by the cell, a Timing Advance (TA) of the terminal based on the SRS; and sharing the updated TA information with other cells via backhaul links.

Here, the method may further comprise performing, by the cell, cooperation for SRS transmission of the terminal with other cell.

According to the above-described cell and terminal discovery methods, a method for a terminal to transmit a trigger signal by using a serving cell resource, a method for a terminal to transmit a trigger signal by using a resource which is not used by a serving cell, a method for configuring discovery signal configuration and association information, and a method for transmitting synchronization signal and measurement signal are provided as a cell discovery procedure based on uplink trigger signal and downlink measurement signal. Also, a terminal discovery procedure and a method for designing discovery signal are provided as a terminal discovery based on uplink trigger signal and uplink discovery signal.

Therefore, cell discovery or terminal discovery may be efficiently performed in cellular mobile communication environments.

### BRIEF DESCRIPTION OF DRAWINGS

FIGS. 1A, 1B, and 1C are conceptual diagrams illustrating cell deployment environments of mobile communication systems.

FIG. 2 illustrates an example of a subframe TX/RX timing of a terminal and a cell.

FIG. 3 illustrates another example of a subframe TX/RX timing of a terminal and a cell.

FIG. 4A is a conceptual diagram illustrating a cell discovery procedure based on uplink trigger signal and downlink discovery signal, and FIG. 4B is a flow chart illustrating a cell discovery procedure based on uplink trigger signal and downlink discovery signal.

FIG. 5 illustrates a transmission example of uplink trigger signal and downlink discovery signal.

FIG. 6A is a conceptual diagram illustrating a discovery procedure based on uplink trigger signal and uplink discovery signal, and FIG. 6B is a flow chart illustrating a discovery procedure based on uplink trigger signal and uplink discovery signal.

FIG. 7 illustrates a procedure in which a terminal transmits a trigger signal by using a serving cell resource and transmits a discovery signal by using a resource which is not used by a serving cell.

FIG. 8 illustrates a procedure for a terminal to transmit discovery signal by using only serving cell resource.

FIG. 9 illustrates a procedure for a terminal to transmit discovery signal by using a resource which is not used by a serving cell.

FIG. 10 illustrates a procedure in a terminal transmits synchronization signal and measurement signal as different signals by using a resource which is not used by a serving cell.

FIG. 11 illustrates a reception time of a subframe transmitted from a terminal at a serving cell.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “terminal” used in this specification may be referred to as User Equipment (UE), a User Terminal (UT), a wireless terminal, an Access Terminal (AT), a Subscriber Unit (SU), a Subscriber Station (SS), a wireless device, a wireless communication device, a Wireless Transmit/Receive Unit (WTRU), a mobile node, a mobile, or other words. The terminal may be a cellular phone, a smart phone having a wireless communication function, a Personal Digital Assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, or also a portable unit or terminal having a combination of such functions. However, the terminal is not limited to the above-mentioned units.

Also, the term “base station” used in this specification means a fixed point that communicates with terminals, and may be referred to as another word, such as Node-B, eNode-B, a base transceiver system (BTS), an access point, etc. Also, the term “base station” means a controlling apparatus which controls at least one cell. In a real wireless communication system, a base station may be connected to and controls a plurality of cells physically, in this case, the base station may be regarded to comprise a plurality of logical base stations. That is, parameters configured to each cell are assigned by the corresponding base station.

Also, example embodiments according to the present invention, which will be explained in the following descriptions, may be supported by at least one standard specification about various wireless communication systems such as an Institute of Electrical and Electronics Engineers (IEEE) 802 system, a 3rd Generation Partnership Project (3GPP) system, a 3GPP LTE/LTE-Advanced system, and a 3GPP2 system. That is, steps or parts which are not explained in the example embodiments in order to clarify technical spirits of the present invention may be supported by at least one of the above standard specifications. Also, all terminologies used for explaining the present invention may be supported by at least one of the above standard specifications.

Hereinafter, embodiments of the present invention will be described in detail with reference to the appended drawings. In the following description, for easy understanding, like numbers refer to like elements throughout the description of the figures regardless of number of the figures.

Cell and Terminal Discovery

A discovery technique for mobile communication systems may be classified into a cell discovery technique and a terminal discovery technique.

The cell discovery performed by a terminal may include a procedure of estimating parameters for the terminal to identify cell identification information and a procedure of measurement for estimating quality of a radio link between the cell and the terminal. Here, the cell identification information, for example, may include a physical cell identity (PCI), a virtual cell identity, etc.

The terminal discovery performed by a cell may include a procedure of estimating parameters for the cell to identify terminal identification information and a procedure of measurement for estimating quality of a radio link between the terminal and the cell. Here, the terminal identification information, for example, may include a cell radio network temporary identifier (C-RNTI).

Cell Deployment Environment

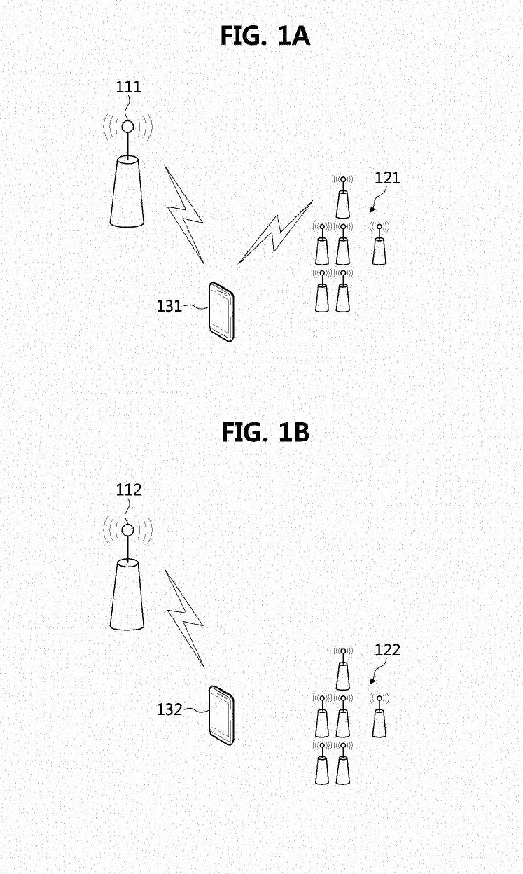

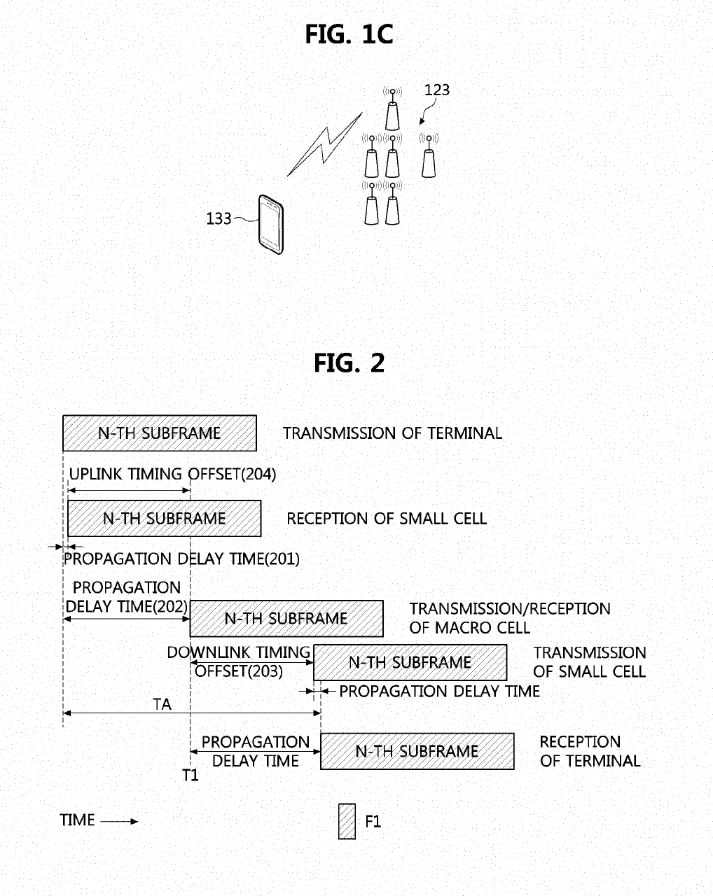

FIGS. 1A, 1B, and 1C are conceptual diagrams illustrating cell deployment environments of mobile communication systems.

A mobile communication network may be configured in a form where small cell clusters 121, 122, and 123 are deployed in the mobile communication network having macro cells 111 and 112. The small cell clusters 121, 122, and 123 may include a plurality of small cells connected through backhaul links. Small cells belonging to each of the small cell clusters 121, 122, and 123 may acquire time synchronization and frequency synchronization through the backhaul links. Meanwhile, time and frequency synchronization between the macro cells 111 and 112 and the small cell clusters 121, 122, and 123 is not always necessary.

When it is assumed that the macro cells 111 and 112 use a first frequency band (F1) and the small cell clusters 121, 122, and 123 use a second frequency band (F2), the first frequency band (F1) and the second frequency band (F2) may be identical to or different from each other.

In the cell deployment environments shown in FIGS. 1A, 1B, and 1C, a terminal may have three types of connections. Here, a connected state may mean a radio resource control (RRC) connected state (RRC_Connected) established between the terminal and a cell.

That is, as shown in FIG. 1A, a terminal 131 may have connected states with the macro cell 111 and an arbitrary small cell included in the small cell cluster 121.

Alternatively, as shown in FIG. 1B, a terminal 132 may have a connected state only with the macro cell 112.

Alternatively, as shown in FIG. 1C, a terminal 133 may have a connected state only with an arbitrary small cell included in the small cell cluster 123.

Cell States

Hereinafter, cell states will be explained.

Table 1 represents cell states. The states of a cell may be represented as a combination of its transmission (TX) status and reception (RX) status.

A state of a cell may be one of states represented in the table 1. Also, a state of a cell may be changed into another state.

TABLE 1

| | | TX | | |
|---|---|---|---|---|
| | | Active | Idle | Inactive |
| | | (TX_active) | (DTX) | (TX_off) |
| RRX | Active | | | |
| | (RX_active) | | | |
| | Idle | | | |
| | (DRX) | | | |
| | Inactive | | | |
| | (RX_off) | | | |

A cell in TX_active state can perform transmission of all signals and channels by using all resources.

A cell in a discontinuous transmission (DTX) state can perform transmission of a discovery signal by using a part of time and frequency resources according to a preconfigured idle time cycle. For example, the cell in DTX state may transmit synchronization signals and cell-specific reference signals (CRS) in a subframe with a 5 millisecond periodicity, and may not transmit any other signals.

A cell in TX_off state cannot transmit any signals.

A cell in RX_active can receive all signals and channels through all resources.

A cell in discontinuous reception (DRX) state can perform reception of signals by using a part of time and frequency resources according to a preconfigured idle time cycle. For example, the cell in DRX state may receive the signals by selecting a specific pair of resource blocks (RB) with a 10 millisecond periodicity.

A cell in RX_off cannot receive any signals.

A small cell may change its state according to a signal received through a backhaul link from a macro cell base station, or change its state by itself. When a small cell base station manages a plurality of cells operating in a plurality of frequency bands, the small cell base station may define a cell state for each of the plurality of cells.

Discovery Types

Hereinafter, various types of discovery will be explained.

Table 2 represents discovery types which are classified according to whether to use a trigger signal and/or a discovery signal. That is, types of cell and terminal discovery may be classified as shown in the table 2.

A trigger signal may be transmitted by a terminal, and cells may measure the trigger signal in order to check approximate proximity between the terminal and the cell.

A discovery signal may be transmitted by a terminal or by a cell according to types of discovery. The discovery signal is used for more accurate proximity measurement, and may include identification information of the cell or the terminal which transmits the discovery signal.

TABLE 2

| Discovery Type | Trigger Signal | Discovery Signal |
|---|---|---|
| 1 | Uplink | Uplink |
| 2 | Uplink | Downlink |
| 3 | None | Uplink |
| 4 | None | Downlink |

A discovery type 1 is a type in which a terminal transmits both the trigger signal and the discovery signal. A discovery type 2 is a type in which a terminal transmits the trigger signal and a cell transmits the discovery signal. A discovery type 3 is a type in which the trigger signal is not used and a terminal transmits the discovery signal. A discovery type 4 is a type in which the trigger signal is not used and a cell transmits the discovery signal.

The discovery signal may include a synchronization signal for synchronization acquisition, and measurement signal for measurement in a terminal.

If the discovery type 4 among the discovery types shown in the table 2 is considered, a serving cell of a terminal may transmit the discovery signal regardless of its cell state.

Cell discovery types may be classified into a type requiring a very-long time, a type requiring a long time, and a type requiring a short time according to a time required for the serving cell to change its cell state. Here, the state of the serving cell may be changed according to a signal from an adjacent small cell or a macro cell, or according to a self determination of the serving cell.

In the type requiring a very-long time, the serving cell of the terminal reports its cell state change to an adjacent cell and performs the cell state change. This type may take several seconds.

In the type requiring a long time, a terminal performs radio resource measurement (RRM) on the discovery signal transmitted by the serving cell, reports the measurement result to the serving cell. Then, the serving cell performs its cell state change according to the RRM result received from the terminal. This type may take several tens of milliseconds.

In the type requiring a short time, although a cell in DTX state does not transmit data and related control information, the cell in DTX state transmits a discovery signal. A terminal performs radio resource measurement (RRM) on the discovery signal transmitted by the serving cell and estimation of channel state information (CSI) based on the measurement, and reports the results to the serving cell according to a predefined manner. This type may take several milliseconds, and cell states may be defined differently from the states defined in the table 1.

Subframe TX/RX Timing Configuration Methods in a Cell.

Hereinafter, methods for configuring a subframe TX/RX timing in a cell will be explained.

In the cell discovery and terminal discovery, when a cell transmits a discovery signal via downlink, it is preferred that the cell transmits its discovery signal according to its downlink subframe TX timing. Also, when a terminal transmits a trigger signal or a discovery signal via uplink, it is preferred that the terminal transmits the trigger signal and/or the discovery signal according to a TX timing determined based on the uplink TX timing used in the serving cell to which the terminal belongs.

Hereinafter, a TX/RX timing when macro cells and small cells use the same frequency band (i.e. F1=F2) will be explained.

First, a TX/RX timing for downlink will be explained.

When physical positions of cells are different, since transmission propagation delays between a terminal and the cells are different, a reception time of a signal transmitted from the terminal in each cell becomes different from each other.

In order to support inter-cell interference coordination (ICIC), coordinated multi-point transmission (CoMP), dual connectivity, etc., it is preferable that a subframe of a serving cell and subframes of neighbor cells of the serving cell are received in the terminal at the same or almost the same time. For example, when the terminal is connected with a macro cell (that is, the serving cell is a macro cell) and small cells exist near the terminal, it is preferable that subframes transmitted from the macro cell and the small cells existing around the terminal are received in the terminal at the same or almost the same time.

Thus, if the propagation delays between transmission points of the cells and the terminal are considered, transmission timing of downlink subframes of the macro cell and the small cells may be configured differently from each other. That is, a subframe transmission time for each of the macro cell and the small cells may be configured differently.

Hereinafter, a TX/RX timing for uplink will be explained.

A case, in which a terminal is served by a macro cell and a small cell and a distance between the terminal and a reception point of the macro cell is much longer than a distance between the terminal and a reception point of the small cell, is considered.

In an aspect of transmission of the terminal, when transmission timings of uplink subframes which the terminal transmits to the serving cells do not coincide with each other, temporally-overlapped areas between the subframes may be generated so that uplink power control cannot be performed by unit of subframe.

That is, it is preferred that transmission timings of uplink subframes for the serving cell of the terminal are configured to be the same or almost the same.

Even when a terminal is served by one of a macro cell and a small cell, if uplink interference control and CoMP operations are considered, it is preferred that uplink subframes transmitted to a macro cell to which the terminal belongs and small cells around the terminal have the same transmission timings or almost the same transmission timings.

FIG. 2 illustrates an example of a subframe TX/RX timing of a terminal and a cell.

As shown in FIG. 2, when a terminal transmits n-th subframe to a small cell and a macro cell by using the same uplink subframe timing, since propagation delay times between the terminal and the cells are different in a case that positions of the macro cell and the small cell are different, reception timings of the n-th subframe at the macro cell and the small cell become different from each other.

That is, when a distance between the macro cell and the terminal is much longer than a distance between the small cell and the terminal, the small cell receives the n-th subframe transmitted from the terminal with a delay time 201 and the macro cell receives the n-th subframe with a delay time 202.

As described above, in order for reception times at the terminal of downlink subframes transmitted from the macro cell and the small cell to be identical (or, almost identical), a transmission time of the downlink subframe of the small cell can be delayed by an amount of a propagation delay time between the terminal and the macro cell as compared to a transmission time of the downlink subframe of the macro cell.

Also, when a terminal uses the same uplink subframe transmission timing for a macro cell and small cells around the terminal, reception timings of uplink frames transmitted from the terminal become different at the macro cell and the small cell. Here, as shown in FIG. 2, if the macro cell configures a transmission time t1 of a downlink subframe to be identical to a reception time t1 of a uplink subframe, the small cell should delay its downlink subframe transmission time by an amount of a propagation delay time between the terminal and a transmission point of the macro cell (i.e. a downlink timing offset 203) as compared to the downlink subframe transmission time of the macro cell, and advance its uplink subframe reception time by an amount of a propagation delay time (i.e. a uplink timing offset 204).

If the macro cell has information on a propagation delay time of a link between a terminal and the macro cell based on a Physical Random Access Channel (PRACH), etc. transmitted by the terminal, the macro cell can transfer the information to small cells around the terminal via backhaul links. Each of the small cells can determine its downlink transmission timing and uplink reception timing based on the information transferred from the macro cell.

Hereinafter, a TX/RX timing, in case that a macro cell and small cells use different frequency bands (i.e. F1≠F2), will be explained.

In an aspect of downlink, it may not be necessary that downlink subframe transmission times of cells using different frequency bands have a specific relationship.

However, considering a case in which cells using different frequency bands and being located in different positions serve a terminal in a manner of inter-site carrier aggregation, since positions of the terminal and the serving cells are different, a plurality of timing advance groups (TAG) need to be used.

Considering an aspect of transmission at the terminal, if transmission timings of uplink subframes transmitted from the terminal to the plurality of serving cells do not coincide with each other, temporally-overlapped areas between the subframes may be generated so that uplink power control cannot be performed by unit of subframe. Thus, it is preferred that transmission timings of uplink subframes for the serving cells of the terminal are configured to be the same of almost the same.

For downlink synchronization acquisition, the small cell may determine its downlink subframe transmission synchronization based on a single received from the macro cell. In this case, the downlink subframe transmission timing of the small cell may be delayed by a transmission delay time between transmission/reception points of the small cell and the macro cell as compared to a downlink subframe transmission timing of the macro cell.

Also, considering an aspect of reception at the terminal, if reception timings of downlink subframes transmitted from the macro cell and the small cell are the same or almost the same, since the terminal can switch frequency bands by unit of subframe when the switching between the frequency bands used by the macro cell and the small cell is necessary, radio resources can be used efficiently. Here, if the macro cell configures it downlink subframe transmission time to be identical to its uplink subframe reception time, the downlink subframe reception time at the small cell should be advanced by a transmission delay time between transmission/reception points of the small cell and the macro cell as compared to the downlink subframe transmission time of the macro cell, and thus the uplink subframe reception timings for the small cell and the macro cell may be configured to be the same or almost the same.

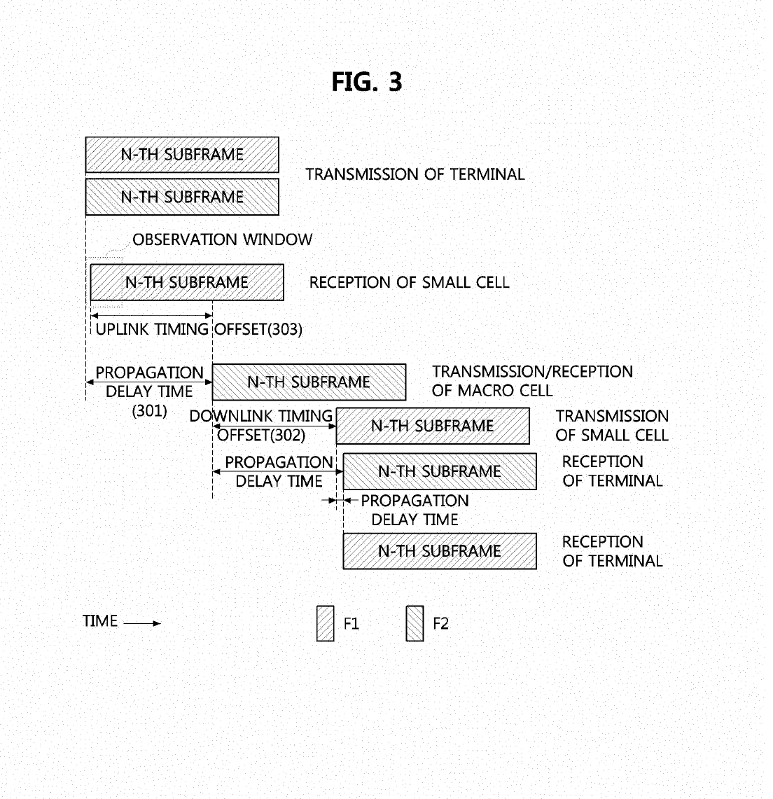

When a service cell of a terminal is a macro cell, if the terminal located around a small cell transmits a subframe for the macro cell using a frequency band F1 and a subframe for the small cell using a frequency band F2 by using the same subframe timing, reception times of the corresponding subframes at the macro cell and the small cell are as shown in FIG. 3. In the case of FIG. 3, a timing advance (TA) of the terminal for the small cell may be configured with reference to a TA of the macro cell, and the small cell transmits its downlink subframe by delaying by a propagation delay time and receives a uplink subframe of the terminal by advancing the propagation delay time, as compared to a downlink subframe transmission timing of the macro cell.

FIG. 3 illustrates another example of a subframe TX/RX timing of a terminal and a cell.

In FIG. 3, an example of a TX/RX timing, when a service cell of a terminal is a macro cell and the terminal located around a small cell transmits a subframe for the macro cell using a frequency band F1 and a subframe for the small cell using a frequency band F2 by using the same subframe transmission timing, is illustrated.

Referring to FIG. 3, a TA of the terminal for the small cell may be configured with reference to a TA of the macro cell. The small cell transmits its downlink subframe by delaying by a downlink timing offset 302 corresponding to a propagation delay time 301 compared to a downlink subframe transmission timing of the macro cell, and receives a uplink subframe of the terminal by advancing a uplink timing offset 303 corresponding to the propagation delay time 301.

When a terminal transmits a trigger signal and/or a discovery signal by using a frequency resource which is not used as a resource for its serving cell, since other cells except the serving cell do not know transmission timing of the terminal exactly, they should approximately estimate a reception time of the trigger signal or the discovery signal. In order for the cells except the serving cell to be able to estimate the reception time of the trigger signal or the discovery signal with low complexity, transmission timing of the trigger signal and the discovery signal of the terminal may be configured to be identical to uplink subframe transmission timing of the terminal which is configured by the serving cell of the terminal.

### [Transmission of Discovery Signal and Discovery Methods Based on Uplink Trigger Signal and Downlink Discovery Signal]

Hereinafter, discovery methods based on uplink trigger signal and downlink discovery signal will be explained.

Cell Discovery Methods Based on Uplink Trigger Signal and Downlink Measurement Signal

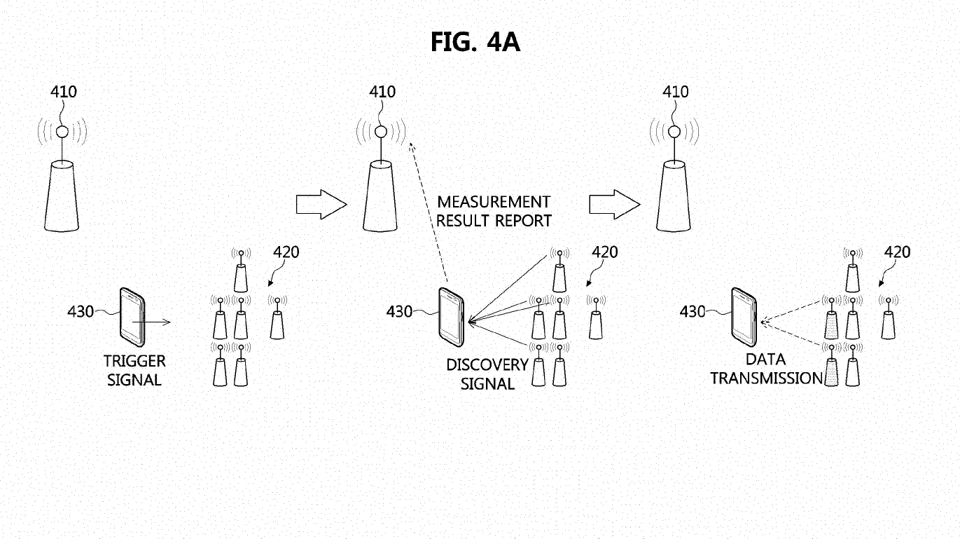

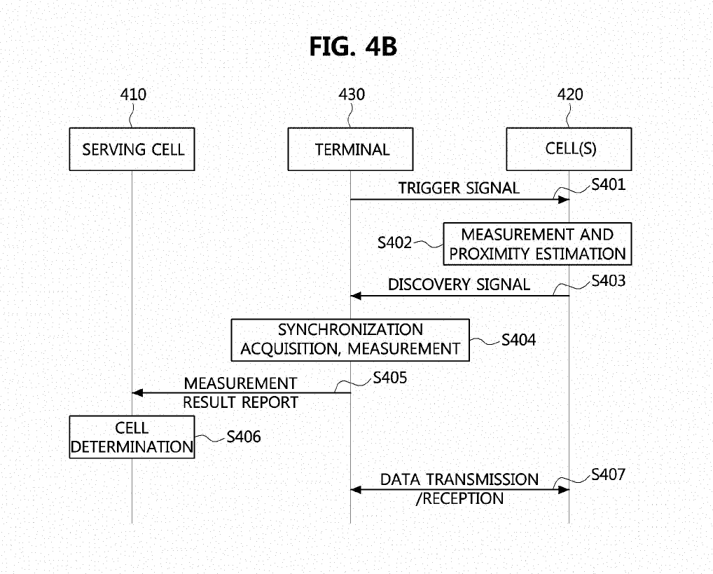

FIG. 4A is a conceptual diagram illustrating a cell discovery procedure based on uplink trigger signal and downlink discovery signal, and FIG. 4B is a flow chart illustrating a cell discovery procedure based on uplink trigger signal and downlink discovery signal.

Referring to FIG. 4A and FIG. 4B, a terminal 430 may transmit a trigger signal to cells 420 (S401). Here, the terminal 430 may be provided with configuration information for configuring the trigger signal from a serving cell 410. Also, the trigger signal may be configured by using a frequency resource of the serving cell, or configured by using a frequency resource different from the frequency resource of the serving cell. For example, when the terminal 430 is served by a macro cell, the terminal 430 may transmit the trigger signal by using a frequency resource used by the macro cell. Alternatively, when the terminal 430 is served by a macro cell and the macro cell and a small cell use different frequency bands, the terminal 430 may transmit the trigger signal by using the frequency resource used by the small cell.

Each of the cells 420 may perform measurement on the trigger signal, and estimate its proximity to the terminal 430 based on the measurement result (S402).

Also, the cells 420 around the terminal 430 may transmit the discovery signals to the terminal 430 (S403). Here, each of the cells 420 may determine whether to transmit the discovery signal based on the proximity to the terminal 430 estimated based on the measurement of the trigger signal. The discovery signal may include a synchronization signal for synchronization acquisition and a measurement signal. Also, the serving cell 410 of the terminal 430 may provide the terminal 430 with association information representing relations between each synchronization signal and measurement signal corresponding to each synchronizations signal.

The terminal 430 may acquire time synchronization by receiving synchronization signal based on the association information. Also, the terminal 430 may identify a measurement signal associated with the synchronization signal based on the association information, perform measurements on the identified measurement signal (S404), and report the measurement results to the serving cell 410 (S405). Meanwhile, the discovery signal may include only the measurement signal without the synchronization signal. In this case, the terminal 430 may receive the measurement signal by using reference time information provided by the serving cell 410, and perform measurements on the received measurement signal.

Then, a specific cell of the cells 420 which will be newly connected with the terminal 430 may be determined based on the measurement result of the discovery signal (S406). Here, the serving cell 410 may determine the specific cell 420 which will be connected with the terminal 430 among a plurality of cells based on the measurement result of the discovery signal received from the terminal 430. Also, the serving cell 410 may transfer information on the determined specific cell 420 to the terminal 430 and the specific cell 420.

The terminal 430 may establish a connection with the specific cell 420, and exchange data with the specific connected cell 420 (S407). Here, the terminal 430 may receive information on the specific cell 420 from the serving cell 410, and establish the connection with the specific cell 420 based on the received information.

Methods for a Terminal to Transmit a Trigger Signal by Using a Serving Cell Resource

Hereinafter, a method in which a terminal transmits a trigger signal by using a resource of a serving cell to which the terminal belongs will be explained in detail.

The serving cell may provide the terminal with configuration information of the trigger signal by using a Radio Resource Control (RRC) signaling or using a RRC signaling and downlink control information (DCI). The configuration information may include information on the signal which the terminal uses for transmission, information on time and frequency resources for the corresponding signal, transmit power information, etc.

Also, the serving cell base station may transfer the configuring information of the trigger signal to other cells in order to a least one cell to be able to receive the trigger signal.

The trigger signal may use a Sound Reference Signal (SRS) or a Physical Random Access Channel (PRACH) for backward-compatibility.

Cells providing services to the terminal using a frequency different from a serving cell frequency should be able to receive the trigger signal transmitted through the serving cell frequency resource and measure proximity to the terminal.

In order to transmit the trigger signal by using the serving cell resources, the terminal may transmit the trigger signal by using a TA configured by the serving cell. Cells located around the terminal may receive the trigger signal earlier than a uplink subframe reception timing of the serving cell, as early as a propagation delay time between the serving cell and the terminal.

A Method of Using SRS as the Trigger Signal

A terminal may transmit SRS as the trigger signal, and cells may measure reception power (e.g. Reference Signal Received Power (RSRP)) of the SRS transmitted by the terminal.

Configuration information needed for the terminal to transmit the SRS using resources of its serving cell and for the cells to receive the SRS and estimate proximities to the terminal may include physical layer cell identification information of the serving cell, configuration information of all parameters needed for receiving the SRS, TA information used for the terminal to transmit the SRS to the serving cell, transmit power information of the SRS, and so on.

Also, the configuration information of all parameters needed for receiving the SRS may include the following information according to a triggering type of the SRS.

The configuration information on parameters of a triggering type 0 SRS may include information about transmission comb, a start point of physical RB assignment, transmission duration, period and subframe offset, bandwidth, frequency hopping bandwidth, cyclic shift, the number of antenna ports used for SRS transmission, etc.

The configuration information on parameters of a triggering type 1 SRS may include information about period and subframe offset, transmission comb, a start point of physical RB assignment, bandwidth, the number of antenna ports used for SRS transmission, etc.

The serving cell of the terminal may transfer the determined parameters to the terminal via RRC signaling or via RRC signaling and DCI when the SRS transmission is triggered. Also, the serving cell may transfer the parameters through a backhaul link to a cell which will receive the trigger signal transmitted by the terminal.

In order for non-serving cells to receive the trigger signal transmitted by the terminal, a procedure in which the non-serving cells obtain reception timing of the trigger signal is necessary.

In a case that a distance between the terminal and the cell is not close sufficiently, since a transmission delay time between the terminal and the cell cannot be identified, a SRS reception procedure should be performed without a derived SRS reception timing. In this case, since the SRS reception timing should be estimated during the SRS reception procedure, processing complexity may be increased.

Generally, for the case that a distance between the terminal and the cell is not close sufficiently, it can be assumed that a radio distance between them is not close. In such the case, the cell may configure an observation window for receiving the SRS, and detect only SRSs arriving within the configured observation window. If the cell does not detect any SRS within the observation window, it can be assumed that the terminal is located far from the cell.

Also, in a case that the cell knows a transmission delay time between the terminal and the serving cell and an uplink reception timing of the serving cell, the cell can estimate a reception timing of the trigger signal by using the transmission delay time under assumption that a distance between the cell and the terminal is close sufficiently. That is, if the distance between the cell and the terminal is assumed to be sufficiently close, since a transmission delay time between the terminal and the cell can be approximated to 0, the cell may try to receive a SRS transmitted by the terminal earlier than the uplink subframe reception timing of the serving cell, as early as the propagation delay time between the cell and the serving cell.

The cell can identify a reception power (e.g. RSRP) of the SRS received from the terminal, and estimate the SRS reception timing more accurately from the received SRS.

In order to enhance accuracy of proximity estimation, the terminal may transmit SRSs periodically, and the cell may also receive the SRSs periodically.

If the SRS transmission of the terminal overlaps transmission of other signals or channels temporally, the transmission of the SRS may be dropped. For example, when a SRS and Physical Uplink Control Channel (PUCCH) format 2a/2b are configured in the same subframe, the terminal may transmit the PUCCH without the SRS.

Also, when a plurality of timing advance groups (TAGs) are configured, in order not to exceed a transmission power restriction, the terminal may drop the SRS transmission when the SRS transmission overlaps transmission of other signals or channels temporally.

Even though the serving cell notifies it to other cells via backhaul links that the SRS transmission is dropped, the other cells may try to measure SRSs unnecessarily due to delays of the backhaul links. Therefore, it is necessary that the cells identify whether SRSs are actually transmitted or not by measuring average reception powers of resource elements to which the SRSs are allocated. For this, as shown in the table 3, two threshold values (T1 and T2), which can be used for identifying whether the SRSs are transmitted or not and used for measuring the distance between the cell and the terminal, may be introduced.

TABLE 3

| Event | Determination of a cell |
|---|---|
| SRS RSRP < T1 | SRS is not transmitted |
| T1 < SRS RSRP < T2 | Far distance between terminal and cell |
| T2 < SRS RSRP | Short distance between terminal and cell |

If the cell determines that SRS is not transmitted, the cell may not determine proximity between the terminal and the cell.

A Method of Using PRACH as the Trigger Signal

A cell may estimate proximity between the cell and a terminal by receiving a PRACH transmitted from the terminal. Configuration information needed for the terminal to transmit the PRACH using resources of a serving cell and for cells to receive the PRACH and estimate proximities to the terminal may include configuration information of the PRACH and transmit power information of the PRACH.

The configuration information of the PRACH may include information on a PRACH transmission subframe or period and subframe offset, frequency position, a type of transmission set needed for RACH sequence generation, RACH root sequence, cyclic shift value, etc.

The serving cell of the terminal may provide the PRACH configuration information to the terminal, and the terminal may transmit PRACH according to the provided PRACH configuration information. Also, the serving cell of the terminal may provide the PRACH configuration information of the terminal to other cells so that each of the cells can receive the PRACH transmitted from the terminal.

The cell may receive the PRACH, and measure reception power strength (e.g. RSPR) of the PRACH.

The cell which received the PRACH should transmit a random access response for the PRACH via downlink. However, in a case that the terminal transmits the PRACH for discovery, a random access process is modified so that the cell does not perform a random access response.

Also, at least one specific sequence among PRACH sequences may be reserved for cell discovery purpose. In this case, a cell may identify a purpose (i.e. for random access or discovery) of the received PRACH by detecting a sequence of the received PRACH.

Thus, in a case that the serving cell instructs the terminal to transmit PRACH for discovery, if the serving cell or other cells receive a PRACH having a specific sequence reserved for discovery, each of them may perform a discovery procedure without transmitting a random access response for the received PRACH.

When a PRACH is used as a trigger signal, since cells already know sequence information and configuration information of the PRACH, proximity to a terminal which transmitted the PRACH can be estimated by comparing a preconfigured threshold value (T2) with reception signal strength (RSRP) of the received PRACH, as shown in the table 4. Also, it can be used for acquiring uplink synchronization between the terminal and the cell.

TABLE 4

| Event | Determination of a cell |
|---|---|
| PRACH RSRP < T2 | Distance between the terminal and the |
| | cell is far |
| T2 < PRACH RSRP | Distance between the terminal and the |
| | cell is close |

A Method for a Terminal to Transmit a Trigger Signal by Using a Frequency which is not Used by the Serving Cell

When the terminal transmits the trigger signal by using a resource of a non-serving cell (i.e. a cell which is not serving the terminal) and frequencies of the serving cell and the non-serving cell are different, there is an advantage that the non-serving cell does not have to perform measurements on other frequencies (inter-site frequency measurements).

Also, when the frequency used by the serving cell and the frequency used by the non-serving cell differ greatly, a proximity measured on the frequency used by the serving cell may not mean a proximity measured on the frequency used by the non-serving cell. Therefore, in such the case, it is preferred that the terminal transmits the trigger signal by using the non-serving cell resources. For example, when the terminal is connected with a macro cell and frequencies of the macro cell and a small cell are different, it is preferred that the terminal transmits the trigger signal by using frequency resources of the small cell.

The serving cell may transfer configuration information of the trigger signal to the terminal by using RRC signaling or using RRC signaling and DCI. The configuration information of the trigger signal may include information on the signal which the terminal uses for transmission, information on time and frequency resources for the signal, transmit power information, etc.

The serving cell base station may transfer the configuration information of the trigger signal to other cells so that at least one cell can receive the trigger signal.

The trigger signal may be transmitted by using a SRS or a PRACH.

When a SRS is used as the trigger signal, the configuration information of the trigger signal may include transmit power information of the SRS and configuration information of parameters according to the following SRS triggering types.

The configuration information on parameters of a triggering type 0 SRS may include information about transmission comb, a start point of physical RB assignment, transmission duration, period and subframe offset, bandwidth, frequency hopping bandwidth, cyclic shift, the number of antenna ports used for SRS transmission, etc.

The configuration information on parameters of a triggering type 1 SRS may include information about period and subframe offset, transmission comb, a start point of physical RB assignment, bandwidth, the number of antenna ports used for SRS transmission, etc.

The serving cell of the terminal may transfer the determined parameters to the terminal via RRC signaling or via RRC signaling and DCI when the SRS transmission is triggered. Also, the serving cell may transfer the parameters through a backhaul link to a cell which will receive the trigger signal transmitted by the terminal.

When a PRACH is used as the trigger signal, the configuration information of the trigger signal may include configuration information of the PRACH and transmit power information of the PRACH.

The configuration information of the PRACH may include information on a PRACH transmission subframe or period and subframe offset, frequency position, a type of transmission set needed for RACH sequence generation, RACH root sequence, cyclic shift value, etc.

The serving cell of the terminal may provide the PRACH configuration information to the terminal, and the terminal may transmit PRACH according to the provided PRACH configuration information. Also, the serving cell of the terminal may provide the PRACH configuration information of the terminal to other cells so that each of the cells can receive the PRACH transmitted from the terminal.

In order to transmit the trigger signal by using resources which are not used by the serving cell, the terminal may transmit the trigger signal by using a TA configured by the serving cell. Cells located around the terminal may receive the trigger signal earlier than a uplink subframe reception timing of the serving cell, as early as a propagation delay time between the serving cell and the terminal.

A Method for Configuring Discovery Signal and Configuring Association Information

The discovery signal may include a synchronization signal for synchronization acquisition, and measurement signal for measurement in a terminal. Hereinafter, a case in which the discovery signal includes both the synchronization signal and the measurement signal will be explained.

The association information of the discovery signal may be information representing relations between each synchronization signal and measurement signal corresponding to each synchronizations signal, and may be transferred from a serving cell to a terminal via RRC signaling. Cells transmitting the discovery signal may transmit one of the synchronization signal and the measurement signal, or transmit both the synchronization signal and the measurement signal according to configuration information of the discovery signal and the association information.

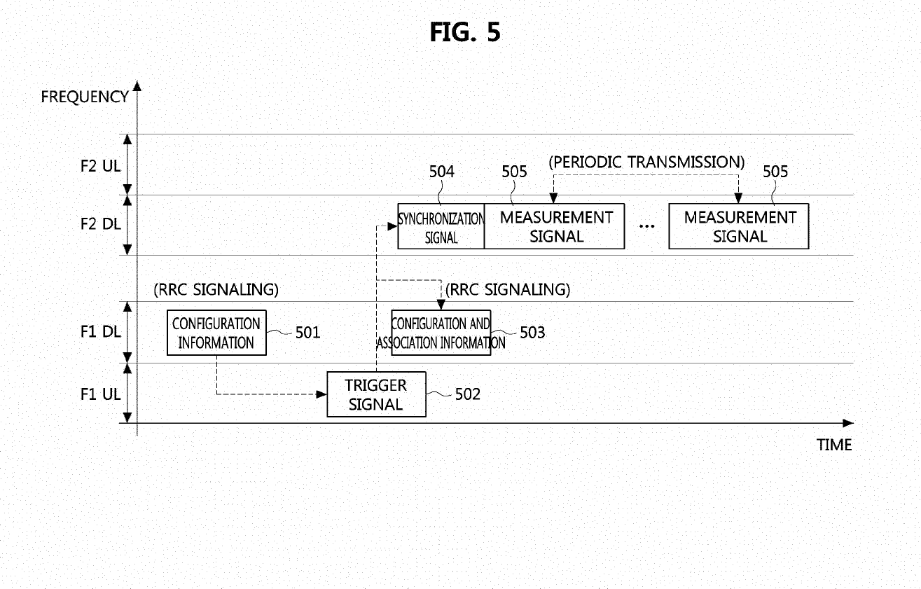

FIG. 5 illustrates a transmission example of uplink trigger signal and downlink discovery signal.

In FIG. 5, an example in which a terminal transmits the trigger signal using a frequency resource (F1) used by a serving cell and transmits the downlink discovery signal using a frequency resource (F2) used by other cell is illustrated.

Referring to FIG. 5, the terminal receives configuration information 501 of the trigger signal from the serving cell via downlink, and transmits the trigger signal 502 according to the configuration information 501 via uplink. Here, the serving cell may transmit the configuration information 501 to the terminal via RRC signaling.

Also, the serving cell may transmit configuration information of the discovery signal and the association information 503 to the terminal and neighbor cells via downlink. Here, the serving cell may transmit the configuration information and the association information 503 to the terminal via RRC signaling, and transmit them to the neighbor cells via backhaul links. The discovery signal includes the synchronization signal and the measurement signal.

The neighbor cells around the terminal may transmit, via downlink, the synchronization signal 504 and the measurement signal 505 based on the configuration information and the association information 503 received from the serving cell.

If each of the cells transmits the configuration information and the association information respectively to the terminal, since each of the cells should be switched to TX_active state to transmit the information, power consumption of each of the cells may be increased. Especially, when a large number of cells exist, as shown in FIG. 5, it is preferred that only the serving cell transmits the configuration information and the association information to the terminal. In this case, power consumption of each of the cells can be decreased, and also latency needed for transferring the information can become shorter.

In the present invention, since the serving sell transfers the configuration information and the association information 503 for the discovery signal to the terminal via RRC signaling, the serving cell cannot identify when the terminal receives the information and starts to detect the discovery signal based on the information. Also, in order to accurately acquire time and frequency synchronization of the discovery signal and enhance quality of measurement, it is preferred that the terminal receives the synchronization signal 504 and the measurement signal 505 several times during a predetermined period. Thus, it is preferred that the cells transmit the synchronization signal 504 and the measurement signal 505 periodically rather than only one time. Here, a transmission cycle of the synchronization signal 504 and a transmission cycle of the measurement signal 505 may be configured to be identical or different from each other.

Configuration information of each synchronization signal may include transmission period and offset of the synchronization signal, frequency position of the synchronization signal, sequence generation information of the synchronization signal, etc.

Configuration information of each measurement signal may include identification information of the measurement signal, transmission period and offset of the measurement signal, frequency position of the measurement signal, sequence generation information of the measurement signal, transmit power information of the measurement signal, etc.

The association information may include identification information of measurement signals each of which corresponds to each synchronization signal.

The terminal may receive measurement signals associated with synchronization signals, as indicated by the association information, with reference to time and frequency synchronization acquired from the received synchronization signal, and perform measurements on the measurement signals.

Meanwhile, the discovery signal may be transmitted as including only measurement signals without synchronization signals. In this case, the terminal may obtain reception timing of the measurement signals from the serving cell of the terminal. For example, the terminal may receive the measurement signals by using timing of the serving cell which is obtained from a Primary Synchronization Signal (PSS), a Secondary Synchronization Signal (SSS), or a Cell-specific Reference Signal (CRS) of the serving cell.

A Method for Synchronization Signal Transmission

The terminal may receive synchronization signal from a small cell before receiving measurement signal from the small cell. The synchronization signal may use PSS and SSS which are defined in the LTE specification.

The small cell may receive the synchronization signal later than a downlink subframe transmission timing of the macro cell, as late as a propagation delay time between transmission/reception points of a macro cell and the small cell.

A Method for Transmitting Synchronization Signal when Small Cells Form a Cell Cluster

When a plurality of small cells form a cell cluster as located adjacently and downlink transmissions of the small cells belong to the cell cluster are synchronized, even though only one or few of the small cells transmits synchronization signal, the terminal can assume that synchronization acquired from the receive synchronization signal is identical to downlink synchronization of the other cells belong to the cell cluster.

If each of the small cells belong to the cell cluster transmit its synchronization signal respectively, performance of synchronization acquisition in the terminal may be decreased due to inter-cell interferences, the number of synchronization signals which the terminal can detect may be reduced.

In order to enhance reception quality of the synchronization signal in the terminal, the following three methods may be considered.
A method of using interference cancellation function in a receiver: in a case that the receiver of the terminal has an interference cancellation function, performance of synchronization signal reception in the terminal may be enhanced by cancelling interferences of the synchronization signals through the receiver.
A method in which only one or some of the small cells transmit synchronization signal: only one or some of the small cells forming the cell cluster may be configured to transmit synchronization signals so that interferences between synchronization signals can be avoided, and performance of synchronization can be guaranteed.

When the serving cell and the small cells are connected through a non-ideal backhaul having latency, since the serving cell cannot change states of the small cells dynamically, it is preferred that each cell determines whether to transmit its synchronization signal independently. For example, each cell may determine whether to transmit its synchronization signal based on results obtained by observing transmission states of adjacent cells through a network listen mode (NLM).
A method of using identical identification information: a plurality of cells forming the cell cluster may not transmit different synchronization signals, and may transmit synchronization signals generated by using an identical sequence based on the same identification information used for the cell cluster. The terminal may acquire downlink synchronization coarsely by using the common synchronization signal for the cell cluster. Then, the terminal may acquire downlink synchronization finely by using a measurement signal received from a specific cell.

Methods for Transmitting Synchronization Signals when Small Cells are Deployed Apart from Each Other

When small cells do not form a cell cluster and so it may not be assumed that the same synchronization is shared between the small cells, each of the small cells should transmit its synchronization signal. In this case, since each of the small cells does not belong to a cell cluster, interferences from other small cells may be not large, and accordingly synchronization performance may not be degraded.

A Method of Transmitting Measurement Signals

A cell may transmit measurement signals based on configured parameters in the association information. For example, Channel State Information Reference Signal (CSI-RS) may be used for the measurement signals. The terminal may perform measurements on the measurement signals based on the configured parameters in the association information.

A Method of Transmitting Discovery Signals for Cell On/Off

As speed of cell on/off is faster as system throughput may become larger. Here, the cell On/Off means cell state switching. That is, it means that the cell state changes from TX_active state to DTX state or from DTX state to TX_active state.

A terminal may measure a discovery signal transmitted from a small cell in TX_active state or in DTX state. In order to increase the speed of cell state switching, the terminal may perform channel measurement of the corresponding cell. In this case, the terminal may perform both RRM measurement and CSI measurement by using the discovery signal.

Considering an environment to which a Carrier Aggregation (CA) is applied, when each of a primary cell (PCell) and a secondary cell (SCell) belongs to a different timing advance group (TAG), a terminal should know a TA value and a transmit power value for transmission to the SCell. Meanwhile, considering an environment to which dual connectivity is applied, when each of a primary serving cell (pSCell) and a secondary serving cell (sSCell) belongs to a different TAG, a terminal should know a TA value and a transmit power value for transmission to the sSCell. For this, a serving cell of a terminal may transmit TA information to the terminal as included in configuration information or association information for discovery signal. Through this, it takes only 4 ms that the terminal receives an uplink grant and transmits a Physical Uplink Shared Channel (PUSCH) according to the received uplink grant.

In order to update a TA value, the terminal may transmit SRS to a small cell in DTX state. It is assumed that an initial TA value can be identified through a random access channel (RACH) procedure between the terminal and the corresponding small cell. In this case, when adjacently-located small cells belong to the same TAG, they may have the same TA value. In this case, it may not be necessary that the terminal transmits SRS respectively for the adjacently-located small cells. That is, the terminal may transmit SRS to only one small cell of the small cells belonging to the same TAG. Then, the small cell which receives the SRS may update the TA value of the terminal based on the received SRS, and share the updated TA information with other small cells by transferring the updated TA value to other small cells. The above procedure is efficient for a case in which small cells belong to the same small cell cluster and share the same TAG.

Also, in an environment of densely-deployed small cells, it is inefficient in a power consumption aspect and may reduce uplink transmission throughput that a terminal transmits SRS respectively for each cell. Thus, SRS control between small cells is required. For example, small cells may perform cooperation for SRS transmission of the terminal by exchanging control information for SRS transmission of the terminal via backhaul.

If a terminal transmits SRS, small cells which receive the SRS may estimate CSI of uplink so as to utilize it for uplink scheduling. Thus, state switching speed of the small cells may be enhanced.

On the other hand, in order to determine a transmission power, the terminal may obtain information on cell-specific reference signal energy per resource element (CRS EPRE) from its serving cell via signaling, and estimate a downlink pathloss based on the information. In a case that a small cell in TX_active state transmits CRS, the terminal can estimate the downlink pathloss based on the CRS. However, since a small cell in DTX state can transmit only discovery signal not CRS, the terminal cannot estimate the downlink pathloss. If a CA environment in which carriers having different TAGs are aggregated or a dual connectivity in which a pSCell and a sSCell have different TAGs is considered, the terminal should estimate the downlink pathloss by using only discovery signal.

For this, the serving cell of the terminal notifies transmission powers of discovery signals transmitted by small cells which are measurement targets of the terminal to the terminal. For example, when a small cell uses CSI-RS as discovery signal, the serving cell transfers CSI-RS EPRE information of the small cell to the terminal. If the terminal estimates the downlink pathloss based on the transmission power of the discovery signal, it is preferred that the estimated information is used for power headroom report (PHR).

### [Discovery Methods Based on Uplink Trigger Signal and Uplink Discovery Signal]

When the number of cells per unit area is very large, it can be expected that the number of terminals existing in a cell area is small. In this case, it is more efficient in aspect of interference management that a terminal transmits measurement signals to cells rather than cells transmit measurement signals. Also, in this case, since both trigger signal and measurement signal are transmitted from the terminal, discovery signal satisfying both proximity identification and proximity measurement can be defined.

Discovery Procedure Based on Uplink Trigger Signal and Uplink Discovery Signal

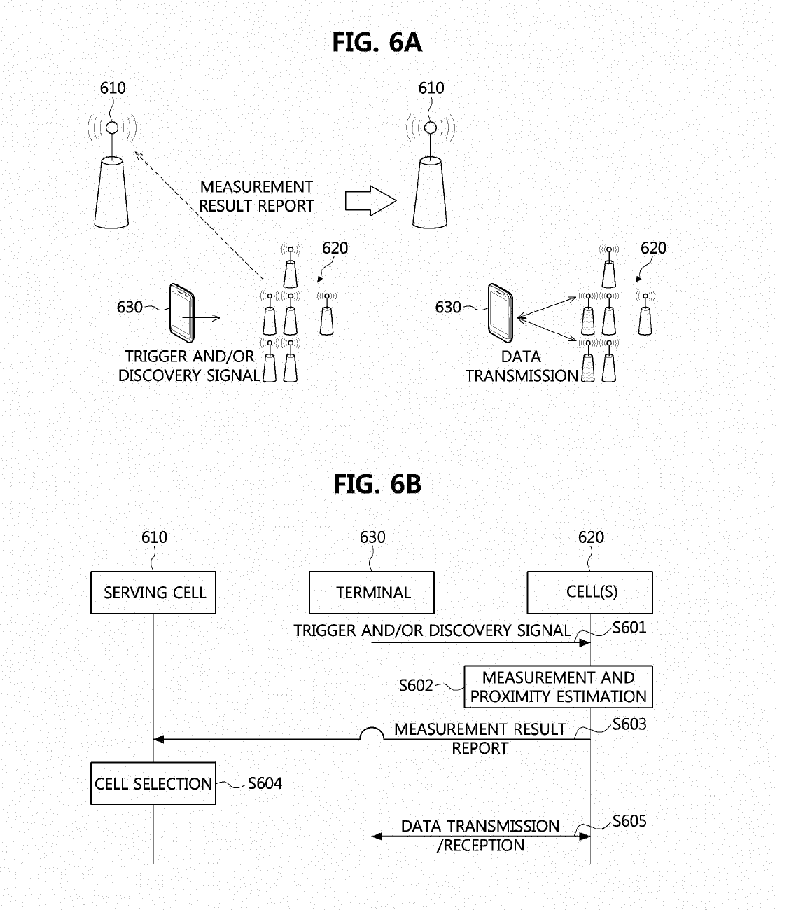

FIG. 6A is a conceptual diagram illustrating a discovery procedure based on uplink trigger signal and uplink discovery signal, and FIG. 6B is a flow chart illustrating a discovery procedure based on uplink trigger signal and uplink discovery signal.

Referring to FIG. 6A and FIG. 6B, a terminal 630 may transmit a trigger signal and/or a discovery signal by using a frequency used by a serving cell 610 or using a frequency which is not used by the serving cell 610 (S601). Here, the trigger signal may be configured based on trigger signal configuration information transferred from the serving cell 610 to the terminal 630 via RRC signaling. Also, the discovery signal may also be configured based on configuration information transferred to the terminal 630 via RRC signaling.

Cells 620 located near the terminal 630 may measure the trigger signal and/or discovery signal transmitted by the terminal 630, and estimate proximities to the terminal 630 based on the measurement results (S602). Here, each cell may not perform the following discovery procedure when it is determined that a distance to the terminal is far, and may perform the following discovery procedure when it is determined that the distance to the terminal is near. That is, cells 620 located near the terminal 630 may report the measurement results to the serving cell 610 of the terminal 630.

The serving cell 610 may select at least one cell which will be connected with the terminal 630 based on the measurement results received from the cells 620 located near the terminal 630 (S604). Here, the at least one cell selected by the serving cell 610 may be switched into TX_active state according to control signaling of the serving cell 610. Also, the serving cell 610 may provide the terminal 630 with information on the at least one selected cell.

The terminal 630 may establish connection with the at least one selected cell, and then perform data communications with the at least one selected cell with which connection is established (S605).

Meanwhile, the discovery signal may include only measurement signal not synchronization signal. In this case, the cell may obtain timing of the measurement signals from the serving cell of the terminal. For example, the serving cell of the terminal may provide the cells receiving the discovery signal with information on a transmission delay time between transmission/reception points of the terminal and the serving cell, and the cells may determine its reception timing of the measurement signal transmitted from the terminal based on the transmission delay time.

Hereinafter, discovery procedures for the terminal to transmit uplink discovery signal will be explained as classified into four cases.

A first case) this is a case in which the terminal transmits a synchronization signal and a measurement signal by using a frequency different from a frequency used by the serving cell and transmits a trigger signal by using a resource of the serving cell. For example, when the terminal is connected with a macro cell and frequencies used by the macro cell and a small cell are different from each other, the terminal may transmit the trigger signal by using a frequency resource of the macro cell and transmit the synchronization signal and the measurement signal by using a frequency resource of the small cell.

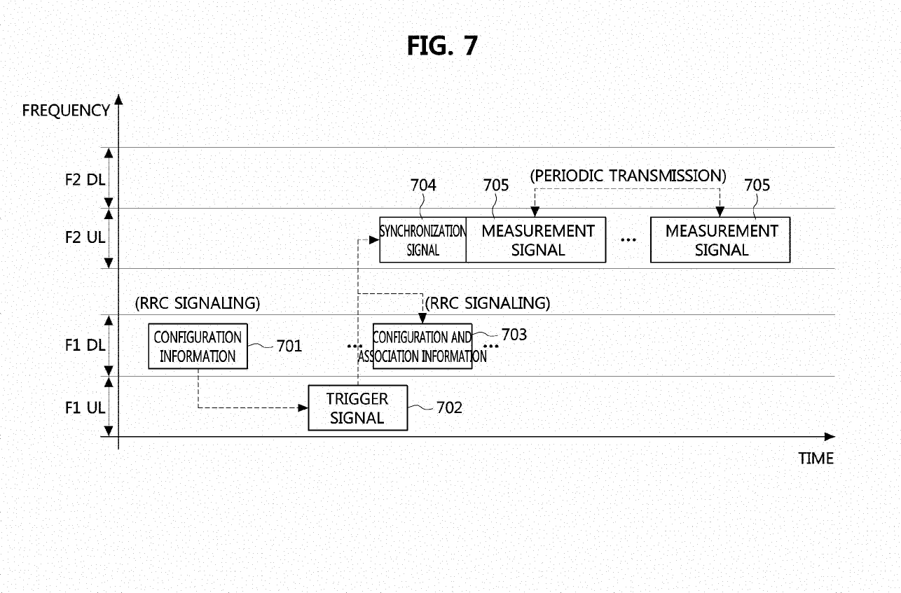

FIG. 7 illustrates a procedure in which a terminal transmits a trigger signal by using a serving cell resource and transmits a discovery signal by using a resource which is not used by a serving cell. In FIG. 7, it is assumed that the serving cell uses a first frequency band (F1) and neighbor cells use a second frequency band (F2).

The serving cell transfers configuration information 701 for the trigger signal which the terminal will transmit to the terminal via RRC signaling.

The terminal may transmit the trigger signal 702 by using a serving cell resource based on the configuration information 701 received from the serving cell.

Cells may determine proximities to the terminal by measuring reception strengths of the trigger signal 702 transmitted from the terminal. If a cell determines that the terminal is sufficiently close to the cell based on the proximity determination result, the cell may report the proximity measurement result to the serving cell.

The serving cell may transfer configuration and association information 703 of the discovery signal (i.e. synchronization signal and measurement signal) to the terminal via RRC signaling. Also, the serving cell may transfer the information 703 to other cells measuring the discovery signal via backhaul links.

The terminal may transmit the synchronization signal 704 and the measurement signal 705 by using a resource (e.g. the second frequency band F2) other than a resource used by the serving cell based on the configuration and association information 703 received from the serving cell. Here, the terminal may transmit the synchronization signal 704 and the measurement signal 705 periodically.

The cells may receive and perform measurements on the synchronization signal 704 and the measurement signal 705 transmitted from the terminal, and report the measurement results to the serving cell of the terminal.

A second case) this is a case in which the terminal transmits discovery signal by using only serving cell resource.

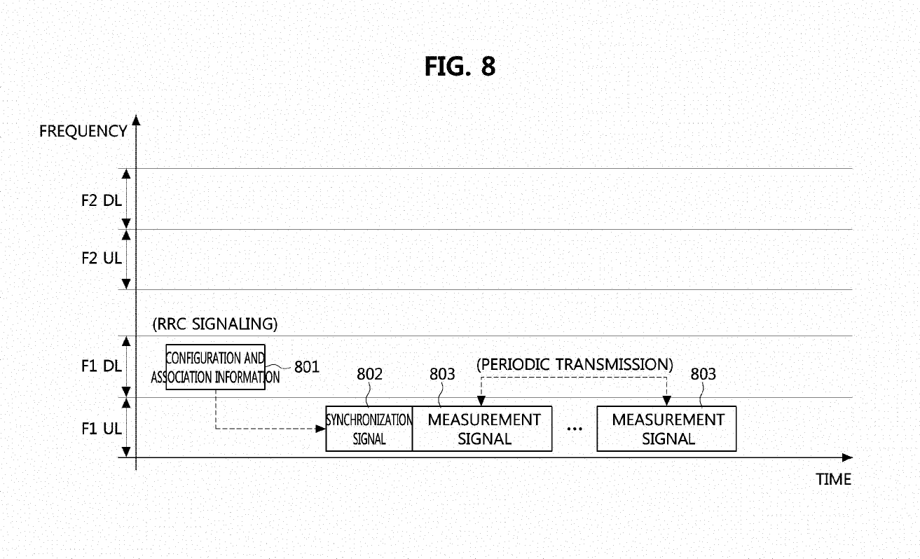

FIG. 8 illustrates a procedure for a terminal to transmit discovery signal by using only serving cell resource. In FIG. 8, it is assumed that the serving cell uses the first frequency (F1).

When the terminal transmits the synchronization signal and the measurement signal by using only serving cell resource, it is not necessary to define a separate trigger signal. Thus, as shown in FIG. 8, the terminal may transmit only the synchronization signal and the measurement signal.

The serving cell may transfer configuration and association information 801 for the discovery signal (i.e. synchronization signal and measurement signal) to the terminal via RRC signaling.

The terminal may transmit the synchronization signal 802 and the measurement signal 803 by using a serving cell resource based on the information 801 received from the serving cell. Here, the synchronization signal 802 and/or the measurement signal 803 may be transmitted periodically.

Cells may obtain transmission timing of the terminal based on the synchronization signal 802 received from the terminal, receive the measurement signal 803 based on the obtained transmission timing, and measure reception strength of the measurement signal 803.

Then, the cells may report the measurement results to the serving cell of the terminal.

(A third case) This is a case in which a terminal transmits the discovery signal by using a frequency other than a frequency used by the serving cell.

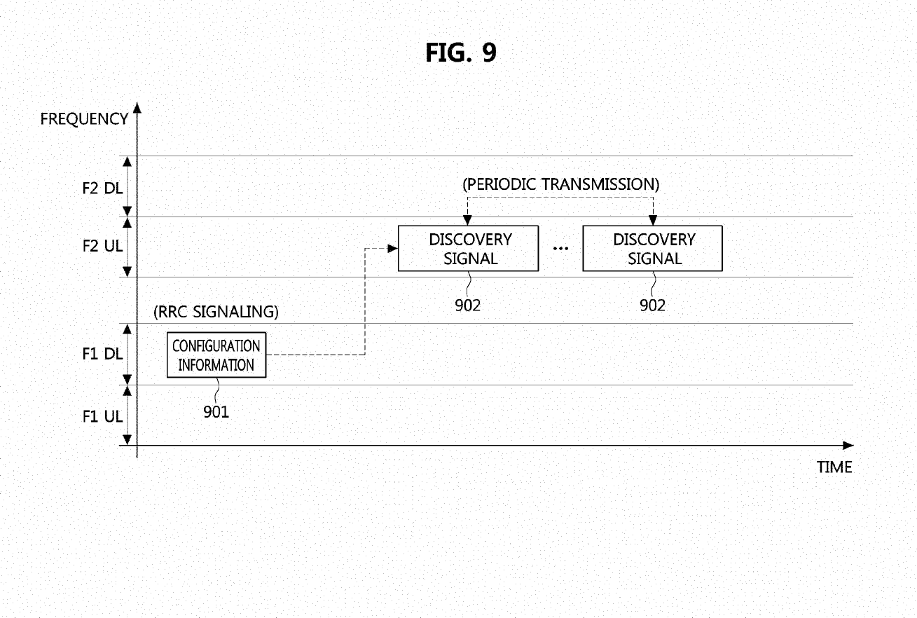

FIG. 9 illustrates a procedure for a terminal to transmit discovery signal by using a resource which is not used by a serving cell. In FIG. 9, it is assumed that the serving cell uses the first frequency (F1) and neighbor cells use the second frequency (F2).

When a single signal is used as both the trigger signal and the measurement signal, the terminal may transmit the discovery signal 902 by using a frequency which is not used by the serving cell (e.g. the second frequency F2) based on configuration information 901 of the discovery signal transferred from the serving cell via RRC signaling. Here, the discovery signal 902 may be transmitted periodically.

Cells may acquire uplink synchronization by receiving the discovery signal 902 transmitted by the terminal, and measure proximities between the terminal and each of the cells and reception powers of the discovery signal 902 based on the acquired synchronization.

Then, the cells may report the measurement results to the serving cell of the terminal.

(A fourth case) This is a case in which two signals different from each other are respectively used as synchronization signal and measurement signal.

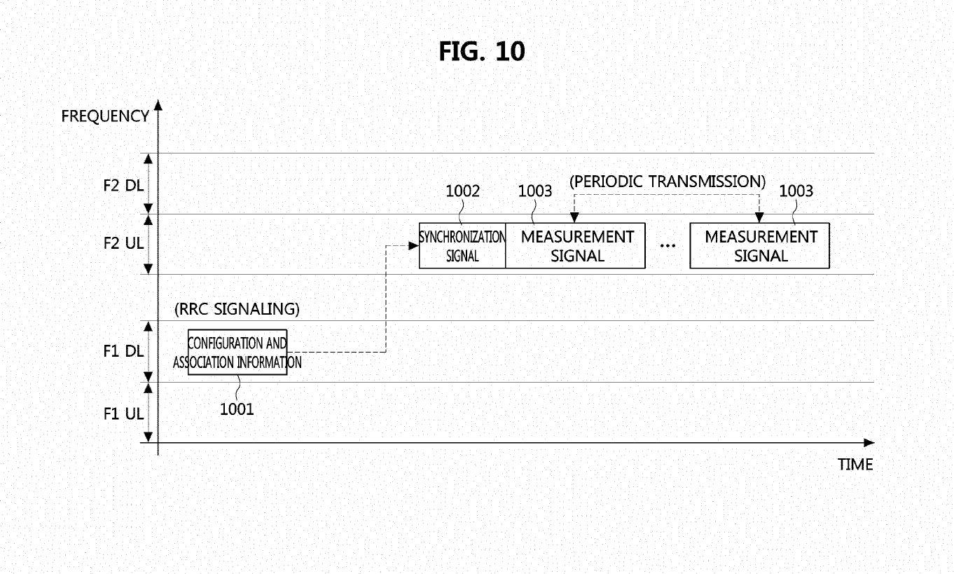

FIG. 10 illustrates a procedure in a terminal transmits synchronization signal and measurement signal as different signals by using a resource which is not used by a serving cell. In FIG. 10, it is assumed that the serving cell uses the first frequency band (F1) and neighbor cells use the second frequency band (F2).

Even when different two signals are respectively used as the synchronization signal and the measurement signal, as shown in FIG. 10, the terminal may generate and transmit the synchronization signal 1002 and the measurement signal 1003 according to configuration and association information for the discovery signal transferred from the serving cell via RRC signaling.

In order to enhance measurement qualities for cells, the synchronization signal 1002 and the measurement signal 1003 may be transmitted with different periodicities.

The cells may obtain transmission timing of the signal transmitted from the terminal by using the synchronization signal 1002 transmitted by the terminal, and measure the measurement signal 1003 transmitted by the terminal so as to estimate proximities between the terminal and the cells.

If each cell determines that the proximity between the terminal and it is sufficiently close based on the estimated proximity, the each cell reports the measurement result of the measurement signal to the serving cell of the terminal.

If the frequency used by the serving cell and the frequency used by other cells are not so much different, the cells may measure proximities between the cells and the terminal and reception strengths of the measurement signal transmitted from the terminal by using the resource of the serving cell. In this case, the terminal may transmit the synchronization signal and the measurement signal by using the resource of the serving cell, and other cells may perform estimation on proximities between the terminal and the cells by measuring the synchronization signal and the measurement signal of the terminal received through the resource of the serving cell.

Methods for Designing Discovery Signal

Cells may measure reception strengths of discovery signal based on uplink transmission timing of the terminal obtained based on the discovery signal transmitted by the terminal. The discovery signal may be designed by utilizing PRACH and SRS defined in the LTE specification.

According to methods of utilizing PRACH and SRS, a case in which PRACH and SRS are respectively transmitted on different subframes and a case in which they are transmitted on the same subframe may be considered.

The terminal may determine uplink transmission timing by using a TA configured by the serving cell, and transmit the discovery signal according to the determined timing.

A Case in which PRACH is Used for Synchronization Signal and SRS is Used for Measurement Signal

A cell may receive PRACH transmitted by the terminal, obtain transmission timing of the terminal, receive the SRS transmitted by the terminal based on the obtained transmission timing, and measure proximity to the terminal and reception strength of the uplink signal.

Identification information of the terminal and configuration and association information of PRACH and SRS for the terminal may be provided by the serving cell of the terminal to neighbor cells. The association information is information defining relations between PRACH and SRS which are transmitted by the terminal, and makes a receiving side know PRACH and SRS which are transmitted by an identical terminal. The serving cell of the terminal may transfer the configuration and association information of PRACH and SRS to the terminal via RRC signaling, and transfer the configuration and association information to other cells adjacent to the terminal via backhaul links.

The serving cell may configure the configuration and association information for PRACH and SRS as follows. That is, the serving cell may configure the configuration and association information of PRACH and SRS for each terminal identification information (i.e. terminal-specific configuration).

The configuration information of PRACH may include information on a PRACH transmission subframe or period and subframe offset, frequency position, a type of transmission set needed for RACH sequence generation, RACH root sequence, cyclic shift value, transmit power information, etc.

Also, the configuration information of all parameters needed for cells to receive the SRS may include the following information according to a triggering type of the SRS.

The configuration information on parameters of a triggering type 0 SRS may include information about transmission comb, a start point of physical RB assignment, transmission duration, period and subframe offset, bandwidth, frequency hopping bandwidth, cyclic shift, the number of antenna ports used for SRS transmission, etc.

The configuration information on parameters of a triggering type 1 SRS may include information about period and subframe offset, transmission comb, a start point of physical RB assignment, bandwidth, the number of antenna ports used for SRS transmission, etc.

The serving cell of the terminal may transfer the determined parameters to the terminal via RRC signaling or via RRC signaling and DCI when the SRS transmission is triggered. Also, the serving cell may transfer the parameters through a backhaul link to a cell which will receive the trigger signal transmitted by the terminal.

A cell may receive PRACH transmitted by the terminal, obtain reception timing for the terminal, and perform measurement on SRS associated with the PRACH based on the configuration and association information.

Here, the terminal may transmit PRACH periodically in order for the cells to accurately estimate reception timing for each terminal. If the terminal is configured to transmit PRACH only one time, information on a subframe through which the PRACH is transmitted is included in the configuration and association information. Otherwise, if the terminal is configured to transmit PRACH periodically, information on transmission period and subframe offset may be included in the configuration and association information.

In a case that the terminal transmits the PRACH for discovery, it is not necessary for the serving cell to transmit a random access response for the received PRACH. Therefore, it is preferable that PRACH sequences for discovery are managed separately from PRACH sequences for random access. If a PRACH sequence used for the PRACH transmitted by the terminal for discovery is a sequence reserved for discovery purpose, or if the serving cell indicated PRACH transmission for discovery purpose to the terminal, the terminal and the serving cell of the terminal may not perform unnecessary random access procedure.

When SRS is used as measurement signal, if the terminal transmits SRS only one time, the type 1 SRS transmission method, which is an aperiodic SRS transmission method, may be used. Otherwise, if the terminal transmits SRS periodically, the type 0 SRS transmission method, which is a period SRS transmission method, may be used. Thus, the configuration and association information of SRS may include configuration information for the type 1 SRS transmission or configuration information for the type 0 SRS transmission according to the selected type of SRS transmission.

PRACH and SRS may be utilized for both proximity measurement and reception strength measurement of measurement signal. When the cells participating in discovery know transmission powers of PRACH and SRS of the terminal, they can perform more accurate proximity measurements. For this, the serving cell of the terminal may notify the transmission powers of the PRACH and SRS to its neighbor cells, and the terminal may transmit the PRACH and SRS according to the transmission powers of the PRACH and SRS which are configured by the serving cell.

A Case in which PRACH and SRS are Allocated in the Same Subframe

Hereinafter, a method in which PRACH and SRS are allocated in the same subframe will be explained.

When a terminal transmits PRACH for random access, a subframe on which the PRACH is transmitted may comprise a cyclic prefix (CP) period, a sequence period, and a guard time period. Among the above periods, the CP period and the guard time period may be defined in consideration of a propagation delay time between the terminal and a cell and delay spread due to multi-paths.

If the propagation delay between the terminal and a serving cell may be identified in advance, the terminal may transmit the PRACH the propagation time earlier so as to make an arrival time of the PRACH sequence at the serving cell the guard time period earlier than a start time of a next subframe in a case of PRACH format 0. In this case, additional signal may be transmitted during the guard time period so that it can be utilized for measurement signal transmission.

In the conventional random access procedure, a terminal transmits PRACH at a reception time of downlink subframe boundary. This means that TA is regarded as 0.

However, in the method in which PRACH and SRS are allocated in the same frame, when the terminal transmits PRACH for discovery, the terminal may transmit PRACH with reference to uplink transmission timing for the serving cell of the terminal. That is, the terminal may transmit start PRACH transmission at a start time of the corresponding uplink subframe transmission.

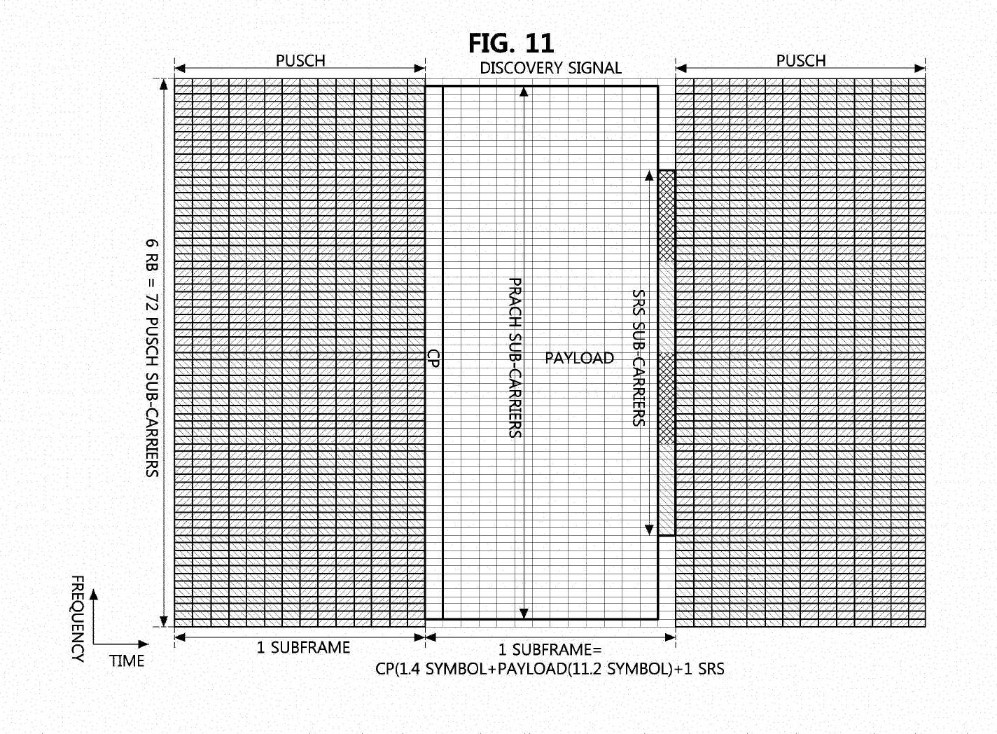

FIG. 11 illustrates a reception time of a subframe transmitted from a terminal at a serving cell.

Referring to FIG. 11, the discovery signal transmitted by the terminal, PRACH format 0 and SRS are allocated in the same subframe. In a case that the terminal transmits the PRACH format 0 TA earlier, the serving cell may receive the PRACH format 0 sequence earlier than a next uplink subframe, as early as the guard time period corresponding to about 1.4 OFDM symbol. Therefore, even when SRS is transmitted at the last symbol of the subframe through which the discovery signal is transmitted, it does not affect transmission of PRACH format 0 sequence. That is, PRACH format 0 and SRS can be allocated in the same subframe as not overlapped with each other. The similar methods can be applied to PRACH formats 1, 2, and 3.

When a terminal transmits discovery signal by using a resource of a serving cell, if a subframe through which the discovery signal is transmitted and a subframe through which other channels (e.g. PUSCH, PUCCH, and PRACH) are transmitted are configured to be identical, reception quality in the serving cell may be degraded due to interferences between the discovery signal and other channels. In this case, in order to enhance the reception quality, it is preferable that the serving cell configures a separate subframe and resource for the terminal to transmit the discovery signal and does not receive other signals and channels transmitted from other terminals through the separate subframe and resource.

When a terminal transmits discovery signal by using a resource which is not used by a serving cell, if terminals in TX_active state do not exist within coverage of a cell participating in the discovery, interferences may not occur. However, if a terminal in TX_active state and being served exists within the coverage of the cell participating in the discovery, in order to enhance reception quality of the cell, it is preferable that a separate subframe and resource are configured for the terminal to transmit the discovery signal so as to avoid interferences with signals and channels transmitted from other terminals.

A Method for Configuring Discovery Signal

A terminal may transmit PRACH and SRS according to configuration information of PRACH and SRS which is provided by a serving cell. The serving cell of the terminal may transfer configuration and association information of the PRACH and SRS to the terminal via RRC signaling, and transfer the configuration and association information to related cells via backhaul links.

The serving cell may configure a transmissions subframe or period, subframe offset, PRACH configuration information, and SRS configuration information for each terminal (i.e. for each terminal identification information).

The configuration information of PRACH may include information on a PRACH transmission subframe or period and subframe offset, frequency position, a type of transmission set needed for RACH sequence generation, RACH root sequence, a cyclic shift value, transmit power information, etc.

Also, configuration information of all parameters needed for cells to receive the SRS may include the following information according to a triggering type of the SRS.

The configuration information on parameters of a triggering type 0 SRS may include information about transmission comb, a start point of physical RB assignment, transmission duration, period and subframe offset, bandwidth, frequency hopping bandwidth, cyclic shift, the number of antenna ports used for SRS transmission, etc.

The configuration information on parameters of a triggering type 1 SRS may include information about period and subframe offset, transmission comb, a start point of physical RB assignment, bandwidth, the number of antenna ports used for SRS transmission, etc.

The serving cell of the terminal may transfer the determined parameters to the terminal via RRC signaling or via RRC signaling and DCI when the SRS transmission is triggered. Also, the serving cell may transfer the parameters through a backhaul link to a cell which will receive the trigger signal transmitted by the terminal.

In order to allocate the PRACH and the SRS in the same subframe, the transmission period and subframe offset should be configured identically when the PRACH and SRS are transmitted periodically, and the transmission subframe should be indicated when the PRACH and SRS are transmitted aperiodically.

In a case that the discovery signal is transmitted by using a resource of the serving cell, if a SRS uses a resource other than a subframe and a resource block occupied by a PRACH sequence, interferences with PUSCH transmitted from other terminal may be generated. Therefore, a separate resource for the discovery signal may be configured in order to the interferences.

Although a bandwidth of SRS may be configured to be multiples of 4 RBs according to the conventional LTE specification, since PRACH uses 6 RBs, it is preferable that the SRS sequence is also configured to use 4 RBs whereby the discovery signal uses 6 RBs. Accordingly, it is preferable that RBs used for the SRS are configured to be included in 6 RBs used for the PRACH by adjusting central frequencies of the SRS and the PRACH.

In a case that the discovery signal is transmitted by using a resource which is not used by the serving cell, it is preferable that the SRS is transmitted within RBs occupied by the PRACH in the subframe on which the PRACH is transmitted. In this case, a position of the SRS in frequency axis and a bandwidth of the SRS can be adjusted so that the SRS is transmitted with the RBs occupied by the PRACH.

Since a random access response of the serving cell for the PRACH transmitted for discovery and uplink synchronization acquisition of the terminal is not necessary, it is preferable that PRACH sequences for discovery and uplink synchronization acquisition of a terminal and PRACH sequences for random access are managed separately. If a PRACH sequence used for the PRACH transmitted by the terminal for discovery is a sequence reserved for discovery purpose, or if the serving cell indicated PRACH transmission for discovery purpose to the terminal, the terminal and the serving cell of the terminal may not perform unnecessary random access procedure.

PRACH and SRS may be utilized for both proximity measurement and reception strength measurement of measurement signal. In order for the cells participating in discovery to perform more accurate measurement of proximities to the terminal, the cells should know transmission powers of the PRACH and the SRS of the terminal in advance. The terminal may transmit the PRACH and SRS according to the transmission powers of the PRACH and SRS which are configured by the serving cell.

While the example embodiments of the present invention and their advantages have been described in detail, it should be understood that various changes, substitutions and alterations may be made herein without departing from the scope of the invention.

What is claimed is:

1. A method for discovering a small cell, performed in a terminal, the method comprising:
receiving discovery signal information of the small cell from a serving cell;
receiving a discovery signal from the small cell based on the discovery signal information, wherein the discovery signal comprises a synchronization signal and a measurement signal;
synchronizing with the small cell by using the synchronization signal, decoding the measurement signal, and performing channel measurement on the measurement signal; and
reporting a result of the channel measurement to the serving cell,
wherein the discovery signal information comprises at least one pair of identification information of the synchronization signal and sequence generation information of the measurement signal.

2. The method of claim 1, wherein the discovery signal information is received from the serving cell via a Radio Resource Control (RRC) signaling.

3. The method of claim 1,
wherein the synchronization signal is configured with a Primary Synchronization Signal (PSS) and a Secondary Synchronization Signal (SSS).

4. The method of claim 1, wherein the identification information of the synchronization signal comprises a Physical Cell Identity (PCI) of the small cell.

5. The method of claim 4, wherein the measurement signal comprises at least one of a Cell Specific Reference Signal (CRS) and a Channel State Information Reference Signal (CSI-RS).

6. The method of claim 1, further comprising in response to the serving cell determining the small cell as a cell which will be connected with the terminal, receiving information on the small cell from the serving cell.

7. A method for discovery of a small cell, performed in a serving cell, the method comprising:
transmitting discovery signal information of the small cell to a terminal, wherein a discovery signal comprising a synchronization signal and a measurement signal is transmitted by the small cell based on the discovery signal information;
receiving, from the terminal, a result of channel measurement performed on the measurement signal; and
in response to the serving cell determining the small cell as a cell which will be connected with the terminal, transmitting information on the small cell to the terminal,
wherein synchronization between the terminal and the small cell is acquired by using the synchronization signal, and
wherein the discovery signal information comprises at least one pair of identification information of the synchronization signal and sequence generation information of the measurement signal.

8. The method of claim 7, wherein the discovery signal information is transmitted to the terminal via a Radio Resource Control (RRC) signaling.

9. The method of claim 7, wherein the synchronization signal is configured with a Primary Synchronization Signal (PSS) and a Secondary Synchronization Signal (SSS).

10. The method of claim 7, wherein the discovery signal information comprises identification information of the small cell, which comprises a Physical Cell Identity (PCI) of the small cell.

11. The method of claim 10, wherein the measurement signal comprises at least one of a Cell Specific Reference Signal (CRS) and a Channel State Information Reference Signal (CSI-RS).
